(19) United States
(12) Patent Application Publication
(10) Pub. No.: US 2004/0017577 A1
(43) Pub. Date: Jan. 29, 2004

(54) Printing system with reduced printer usage

(76) Inventors: Lewis S. Ostrover, Los Angeles, CA (US); Christopher R. Odgers, Claremont, CA (US)

Correspondence Address: GOTTLIEB RACKMAN & REISMAN PC, 270 MADISON AVENUE, 8TH FLOOR, NEW YORK, NY, 100160601

(21) Appl. No.: 10/201,120

(22) Filed: Jul. 23, 2002

(51) Int. Cl. G06K 1/00; G06F 15/00

(52) U.S. Cl. 358/1.8; 358/1.14; 358/1.15

(57) ABSTRACT

A printing system includes a print optimizer adapted to receive a digital file representative of an original document. The print optimizer generates from the digital file a modified file representative of a modified document having fewer pages. The print optimizer can eliminate unnecessary or unwanted content elements (such as graphic elements, including images) from the original document, and/or can change its print characteristics, such as font size, font type, spacing between lines, spacing between characters, single/double sided printing, etc.

### BACKGROUND OF THE INVENTION

A. Field of Invention

This invention pertains to a system which is selectively adapted to modify documents to be printed so as to reduce printer usage and the number of sheets of paper to be used. One such modification includes the deletion of unwanted or superfluous text and/or other material, such as pictures, graphs, etc. Another modification entails changing various print characteristics.

B. Description of the Prior Art

Prior to the advent of modern office equipment, the generation of various documents was done by hand and was very labor intensive. As a result, the lengths of these documents was generally limited. Since copying was also a manual endeavor, documents were usually duplicated only when absolutely necessary. Hence the number of sheets of paper used, and, therefore, the amount of natural resources used was severely limited.

Modern automated electronic equipment enables the generation of documents automatically, at a relatively low cost. Thus the lengths and sizes of these documents have increased considerably. Moreover, copy machines are widely available that have the capability of acting as printers as well. Thus, large documents and numerous copies of these documents are produced with ease, either by printers or print-capable copiers. However, the amount of resources required to produce these documents, including the paper and other staple materials, such as inks, toners, etc., has increased as well. Since the modern electronic equipment used to produce these documents also has the capability of storing the documents electronically, there was some expectation that business would rapidly convert to a ‘paperless office’ thereby eliminating the need for paper copies, and reducing the consumption of other associated resources as well. However this reduction has not occurred for a variety of reasons. Individuals prefer to read and handle hard copies of documents. Moreover, due to the ubiquitous nature of printers, any number of copies of documents can be printed at any time at a touch of a button. As a result, it has been documented that more paper is being wasted and more resources are being consumed than ever before, not to mention time and energy wasted in printing unwanted or unnecessary materials.

Some applications have the capability of allowing an user to choose the size (which, in this case, means the number of pages) of the document. For example, Corel WordPerfect 10 allows an user to access a feature named “Make it Fit” that allows a user to increase or decrease the number of pages of a document. The application changes the document by changing one or more parameters selected by the user. Specifically, the application allows the user to alter the margins, font size and/or line spacing. The application then decides, using some predetermined criteria, how to alter each of these and other parameters to scale the document to the desired size. However, the user cannot dictate how to change each parameter. Moreover, this “Make to Fit” feature is not related to the print feature of the application, and only applies to Corel WordPerfect.

### OBJECTIVES AND SUMMARY OF THE INVENTION

Generally speaking, an objective of the present invention is to provide a system in which the lengths or sizes of documents are reduced before printing. In this manner, the number of sheets, and hence the number of paper pages required is reduced substantially. Moreover, the consumption of other printing-related staple items is also reduced, as well as printer wear and tear, energy and time.

Briefly, a system constructed in accordance with this invention includes an application that generates a digital file representative of an original document. The original document may include necessary content elements, such as text, and unnecessary content elements, such as graphic elements, including images. The original document also includes print characteristics such as font sizes, font types, line spacing, character spacing, word spacing, single/double sided printing, orphan/widow control, etc.

A print optimizer intercepts the digital file and then modifies or converts it into a modified file that is representative of a modified document having fewer pages than the original document. Hence paper, energy, time and other printer-related staple items such as ink, toner, etc, are saved if the modified document is printed instead of the original document.

The print optimizer analyzes the original document to identify unnecessary content elements, such as graphic elements, headers and footers in e-mail, empty columns and rows in a spread sheet, and eliminates them thereby generating a modified document that is smaller than the original document.

The print optimizer also modifies print characteristics of the original document, such as font type, font size, line spacing, character spacing, word spacing, resizing, single/double side printing and widow/orphan control, just to name a few.

The print optimizer operates in accordance with a set of rules that dictate which of the print characteristics should be modified and how. The set of rules can be preset or can be generated using heuristic criteria.

Once the modified file is generated, a preview is generated that is used to determine whether the corresponding modified document should be accepted or rejected. This preview may include an image of the modified document or may include the number of pages in the original and the modified document. The decision to accept or reject a modified document can be made by an operator, or can be made digitally and automatically.

A printer is then used to print either the original or modified document.

The print optimizer can be implemented as a discrete element, as software, or can be incorporated into applications, printer spoolers, or other printer circuitry.

### BRIEF DESCRIPTION OF THE DRAWINGS

FIG. 1 shows a block diagram of a system constructed in accordance with this invention;

FIG. 2 shows a general flow chart illustrating the operation of the invention;

FIGS. 3a, 3b and 3c show the widths of the same text for different fonts or font sizes;

FIG. 4 shows a flow chart for selecting the settings for the system of FIGS. 1 and 2.

### DETAILED DESCRIPTION OF THE INVENTION

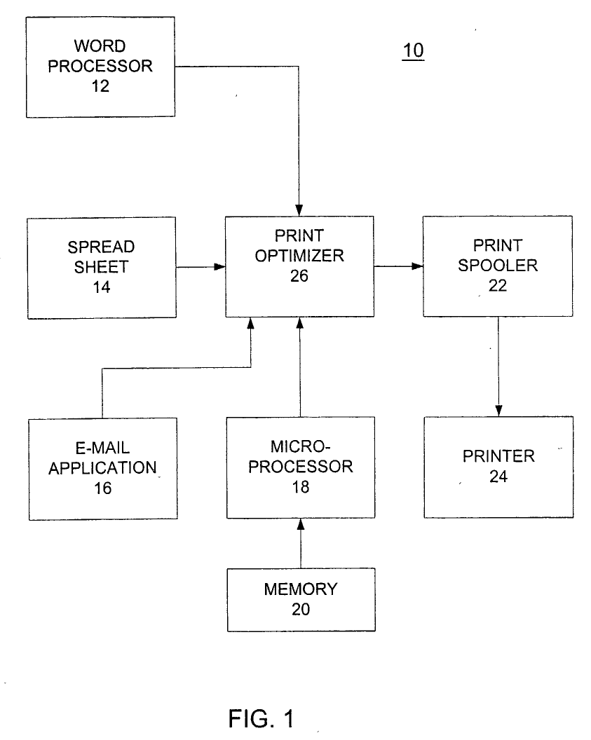

FIG. 1 shows a document processing system that may be based on a desktop PC, an Apple computer, a laptop, or any other similar arrangement, the system having been modified to optimize the printout process to reduce the consumption of associated resources (such as paper, inks, chemicals, time, energy, etc.). The system 10 includes one or more document producing applications such as a word processor 12, a spread sheet application 14, an e-mail application 16 and/or any other application that may be used to generate documents in the form of respective digital files. The system 10 is controlled by a microprocessor 18 on which the various applications run. In FIG. 1 the applications 12, 14, 16 are shown as separate elements for the sake of clarity. The system further includes a memory 20 used to store various application programs, digital files generated by the applications, and other data.

After an user completes a document (at least partially) he can request a hard copy. Ordinarily, in response to this request, the corresponding digital file is sent to a cache, such as a printer spooler 22. The spooler 22 orders the digital files to be printed in a predetermined sequence or cue, for example on a first-in-first out basis. Each digital file in the cue is then sent to the printer 24 for printing.

In the present invention, in one embodiment shown in FIG. 1, each digital file is intercepted by a print optimizer 26. The purpose of the print optimizer 26 is to modify the digital file in a manner selected to reduce the size of the document generated by the printer. Moreover, in some instances the amount of chemicals and other resources is also reduced considerably.

The print optimizer 26 has several modes of operation. In one mode, the optimizer is disabled, and all the digital files from the various applications are able to pass through the optimizer without being modified.

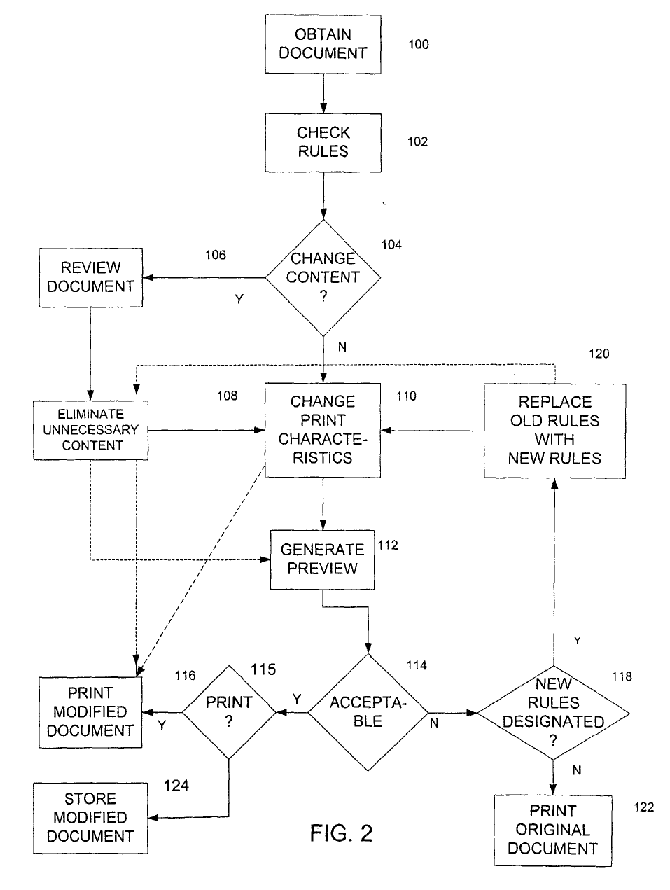

If the print optimizer 26 is activated, it operates on the files in accordance with a set of rules stored in memory 20. Referring to FIG. 2, in step 100 the print optimizer 26 obtains a digital file that may have to be modified. This digital file may originate from directly from an application, or it may be stored in a memory (such as 20). In step 102 the optimizer checks the applicable rules. These rules may be applicable to the files from all applications, or may be application-specific. The rules further define two different types of operations that the optimizer 26 can be perform: one operation that changes the content elements of the digital file (usually by omitting some unnecessary elements while leaving other elements intact); and another operation that rearranges, resizes or otherwise modifies the print characteristics of the respective digital file and/or the printing operation. Details of both types of operations are discussed more fully below.

The type of operation to be performed on the current digital file is checked in step 104. If content changes are required then in step 106 the document is reviewed to identify the unnecessary content elements. The nature of these unnecessary content elements depends to a large extent on the type of document being processed. For example, if the document includes alphanumeric text and images, e.g., a newspaper or magazine article, then, in some instances, eliminating the images saves considerable amount of space. Moreover, since the printing of images can be a slow process, a further advantage in eliminating images from a document is reduced printing time. In this context, the term ‘images’ refer to any graphical element such as pictures, graphs, drawings, etc.

Other types of documents, such as e-mail messages, technical publications or legal opinions, and spread sheets may also include unnecessary content elements. For example, e-mail messages from application 16, may include headers and footers that identify various IP addresses and other information. This information may be important for IT personnel, however, it has little or no meaning to an average person, and little or nothing is lost if it is deleted.

Similarly, technical publications and legal opinions, include numerous footnotes and endnotes which identify reference information and other material that is of little or no importance to an average reader. Therefore, in many instances footnotes, endnotes can be deleted.

Spread sheets are often generated with a large number of empty rows and columns. Since no information is imparted by these elements, they may be deleted as well.

These unnecessary content elements are identified by optimizer 26 in step 106. In step 108 a modified digital file is generated by removing these undesirable content elements.

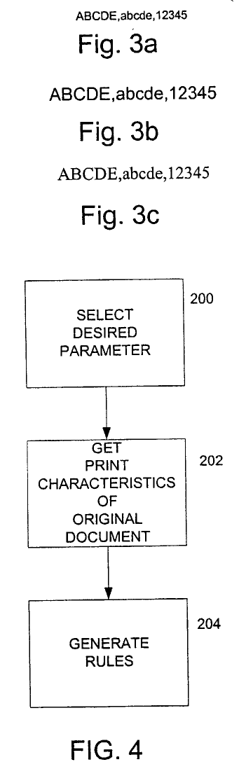

If in step 104 it is determined that no content change is to be performed then in step 110 a modified digital file is generated in which the print characteristics of the original documents are changed. These print characteristics include font type, font size, spacing between lines, spacing between letters on a line (including kerning), widow and orphan control, single side or double side (i.e., whether the documents prints on only one, or both sides of a page) and so on. Some of these characteristics are printer dependent and some of them are application dependent. However, all of them have an effect on the size of the printed document. For example, FIGS. 3a, 3b and 3c show the same sequence of characters ABCDE.abcde.12345. However, in FIG. 3a an 8-point Arial font is used, in FIG. 3b a 12-point Arial font is used and in FIG. 3c a 12-point Times Roman font is used. As can be seen in these Figures, the height of the sequence depends primarily on the size of the font, while the width depends on both the size of the font and the font type. Thus, the sequence in Times Roman font is narrower than the sequence in Arial font, even if the fonts have the same size (in this case 12-point).

Returning to FIG. 2, in step 110 the digital file is modified in accordance with a preselected set of rules designed to reduce the size of the resulting printed document. A typical set of rules may require the following printing characteristics:

| Font type | Times Roman |
|---|---|
| Font size: | 6-point |
| Orphan/widow control: | off |
| Spacing between letters: | minimal |
| Spacing between words: | one letter space |
| Spacing between lines: | single |
| Print on both sides of page: | on |

After the digital file is modified, in step 112 an image of the resulting document may be generated. The purpose of this step is to allow the determination of whether the resulting document is acceptable or not. At least some times, this decision is based on subjective criteria. Some users may find a modified document acceptable, while others may find it unreadable, or otherwise unsuitable.

In addition, or instead of generating an actual image of the document, the size (or total number of pages) of the original document and the modified document may be indicated in step 112. This information may also be valuable in deciding whether to accept the modified document or not. For example, if the original document has 225 pages and the modified document has 175 pages then clearly the modification results in substantial savings. However, if the original document is 45 pages and the modified document has 43 pages, the savings are marginal and hence may not be warranted.

The decision to accept or reject the modified document is made in step 114. As discussed above, since some of the criteria are subjective, the decision should be made by the user. However, the process may also be automated, for example by taking a ratio of the page numbers in the modified and original documents. If this ratio is above a threshold (for example 90%) the modified document may be found unacceptable, while a ratio below the threshold may be acceptable.

Alternatively, the actual number of pages saved may be used as a criteria for the decision.

If in step 114 the modified document is acceptable, then in step 115 the operator is given an option of printing the modified document or storing it. While in most cases it is expected that the modified document will be printed, in some instances, the user may want to store the modified document (for instance in memory 20) and to print it at a later time. As discussed above, the original document may be stored in memory 20 as well. Alternatively, the user may elect to send both the original and the modified document to another party. The original and the modified document may be stored as two separate files. Alternatively, a separate modification file may be generated and saved defining the modifications performed in step 112 (and or 108). At a later time the modified document may be recreated from the original document and the modification file.

If desired, the modified digital file is sent to the printer and printed in step 116. Alternatively, the modified file is saved in step 124 as discussed above. Of course, the modified document can be printed and saved at the same time.

Returning to step 108, after the digital file is modified by eliminating the undesirable content elements, the resulting digital file can be further modified in step 110 by changing the print characteristics of the document.

Alternatively, the modified digital file may be used to generate an image of the modified document in step 112 and to make a decision in step 114 to decide whether the modified document is acceptable or not.

A third alternative from step 108, also indicated in FIG. 2, is just to print the modified document in step 116.

It should be understood that a modified document may be rejected in step 114 either because it is difficult to read (or has some other unacceptable characteristics), or because the savings are insufficient. Therefore, if in step 114 the modified digital file is rejected then in step 118 the user is given the opportunity of designating some new rules. If the user desires to designate new rules, then in step 120 the old rules of step 102 are replaced with new rules and the process continues with step 110 (or 108). The designation of new rules may involve retrieving of a new set of predetermined rules from memory 20 or changing some of the existing rules. For example, the user may want to change only the size of the font, or only the font type. He can make this change in step 120.

If in step 118 the user indicates that he does not want to change the rules, then in step 122 the original digital file is sent to the printer and the original document is printed.

Steps 112, 114, 120, 118, 122 and 124 could be omitted and printing of the modified document may occur right after step 110.

The rules used in steps 102, 110 can be preset without giving the user a chance to select any of the printing characteristics. For example, the rules may be used to set the printing characteristics defined above.

Alternatively, the rules may be selected at the time the print optimizer 26 is installed and/or at any time a document is to be printed. The user can then be presented with a list of all the different print characteristics that can be adjusted and given the choice to set all or some of the print characteristics. Some users may choose to change the size of the fonts, some users may choose to change the size and type of font, some users may choose to go from one sided to two sided printing, and so on. Moreover, if desired these choices can be made on a document by document basis.

In another embodiment of the invention, a set of rules may be derived dynamically. For instance, as shown in FIG. 4, in step 200 at the beginning of a print reduction process the user enters a desired or target number of pages or a target percentage, such as 90% (meaning that the user wants to reduce the size of the document by 10%). Instep 202 the print characteristics of the original document are obtained. In step 204 a set of heuristic guidelines are used to generate a set of rules for generating the modified document. These heuristic guidelines may take various parameters into consideration to determine which printing characteristics are to be modified and how. For example, if the user would like to reduce the document size by 5%, the heuristic rules may indicate that it is sufficient to reduce only the font size by one point, and to leave all other print characteristics untouched. As the amount of desired reduction increases, it is expected that more and more of the print characteristics have to be modified. As part of this process, other content elements, such as images or tables may also be scaled down. These heuristic guidelines are easily determined by analyzing the effects of various changes and by printing various samples. Of course, it is to be understood that whatever rules are preselected or generated must be compatible with the printer 24. For example, a double sided printing cannot be selected if the printer 24 is incapable of this type of operation.

As discussed above, the print optimizer can be operated in a number of different modes. In one mode, the print optimizer 26 is selectively enabled or disabled by the user for each original document generated by one of the applications 12, 14, 16. In this mode the print optimizer can be enabled directly by a command from the microprocessor 18. Alternatively, the print optimizer may be enabled indirectly. For example, the applications may be modified to allow the user to select a printing function with or without optimization. Thus every document generated by the respective application includes in its header a code indicating the user's choice. When the print optimizer intercepts the document, it first checks the document to determine whether or not the user has requested optimization.

The modes of operation described thus far are suitable for an user that works independently, in an office, or at home. Very often, however, users work or perform their functions within a large organization which may have its own standard operating procedures. One of these procedure may pertain to the use of print optimizers. For example, an organization may decide that all printing is to be optimized and furthermore, that this optimization must be performed using certain preselected rules that are stored in memory 20 and cannot be changed by the user. In these situation, a password protection scheme is implemented to insure that IT or other authorized personnel can access, and change the print optimization rules.

Another mode of operation, a set of rules may be stored in the memory 20 which specify certain allowable ranges for various print characteristics. For example, the rules may allow only the use of Arial, Times Roman, and Courier fonts, having sizes 8-14. The user may then be given the leeway of selecting whatever print characteristics he desires, as long as they are within the designated ranges.

The system 10 is shown as having various components in a single location, it being understood that some of the components, including printer 24, memory 20, etc., may be networked and may be physically located remotely from each other. Similarly, while the original documents are generated by applications such as 12, 14, 16, they need not be received directly by the print optimizer 26. Instead, in some instances, the documents may be stored in a memory, such as memory 20, and then retrieved at will for printing.

The print optimizer 26 is shown in FIG. 1 as a discrete element for the sake of clarity. It should be understood that it may be implemented as a discrete electronic circuit, it may be implemented by software, it may be incorporated into one or more of applications 12, 14, 16, it may be incorporated into the print spooler 22 or even the printer 24 itself if the printer is sophisticated enough.

The print optimizer 26 may also be provided as printer driver software that is installed on the operating system running on microprocessor 18.

Printers receive information in the form of electrical signals and generates images corresponding to the information. Printers generally fall into one of two categories. Most printers receive the information in a standard format and have on-board electronic circuitry (known as the raster image processor) that renders the information into an image. However, a cheaper type of printer is also known that does not have this latter circuitry and, instead, makes use of the microprocessor to perform the conversion. The present invention can be used for both kinds of printers. Moreover, if the second type of printer is used in system 10, then the print optimizer can be incorporated into the subroutine used to perform the image rendering as well.

In summary, all digital files with content defining documents (including documents with text, images or mixture thereof) are selectively reviewed and modified to generate a modified document that is smaller than the original. This process results in a printing process that requires less paper, toner and other printer-related resources. Generally, two kinds of modifications are contemplated. The first type of modification involves changing the content of the respective document. In this modification, undesirable content elements (such as images, graphs, etc.) are eliminated. The second type of modification changes the printing characteristics of documents in any manner selected to reduce the size of the documents.

While the invention has been described with reference to several particular embodiments, it is to be understood that these embodiments are merely illustrative of the principles of the invention. Accordingly, the embodiments described in particular should be considered as exemplary, not limiting, with respect to the following claims.

I claim:

1. A printing system comprising:
a print optimizer means adapted to receive a digital file, said digital file defining an original document having an original document size; and
control means adapted to generate commands to said print optimizer;
wherein said print optimizer in response to said commands modifies said digital file to generate a modified file, said modified file defining a modified document having a modified size smaller than said document size;
wherein printing said modified file results in said modified document with less pages than printing said digital file.

2. The system of claim 1 further comprising a printer used to print selectively at least one of said original and said modified documents.

3. The system of claim 1 wherein said print optimizer means is adapted to modify said digital file by changing the contents of said original document.

4. The system of claim 3 wherein said original document has printing characteristics and wherein said print optimizer means is adapted to modify said digital file by changing said printing characteristics.

5. The system of claim 4 wherein said printing characteristics are selected from the group consisting of font types, font sizes, line spacing, letter spacing, word spacing, single/double sided printing and widow/orphan control.

6. The system of claim 1 further comprising a memory means used to store a set of rules, said print optimizer means being adapted to modify said digital file in accordance with said rules.

7. A document printing system comprising:
an application adapted to generate an original file representative of an original document, said original document being printable on several pages; and
print optimizer means for receiving said original file and generating in response to a command a modified file representative of a modified document, said modified document being printable on less pages than said original document.

8. The system of claim 7 wherein original document includes necessary and unnecessary content elements and wherein said print optimizer means is adapted to selectively delete said unnecessary content elements.

9. The system of claim 7 wherein said original documents includes print characteristics and wherein said print optimizer means is adapted to modify said original file by modifying said print characteristics.

10. The system of claim 9 wherein said print optimizer means is further adapted to generate preview information.

11. The system of claim 10 wherein said print optimizer means is adapted to generate preview information including an image of said modified document.

12. The system of claim 10 wherein said print optimizer means is adapted to generate information regarding the number of pages in said original and said modified document.

13. The system of claim 10 further comprising decision means adapted to accept or reject said modified file based on said preview information.

14. The system of claim 13 wherein said decision means is responsive to commands from an operator.

15. The system of claim 14 wherein said decision means is adapted to accept or reject said modified file automatically.

16. The system of claim 13 further comprising printer means adapted to print one of said original and modified documents in accordance with signals from said decision means.

17. The system of claim 7 further comprising a memory used to store a set of rules, said print optimizer means being operated in accordance with said rules.

18. The system of claim 7 further comprising rule selection means adapted to generate said rules.

19. The system of claim 18 wherein said rule selection means is responsive to commands from an operator.

20. The system of claim 7 wherein said print optimizer means is incorporated in a printer driver.

21. The system of claim 7 wherein said print optimizer means is incorporated in said application.

22. The system of claim 7 wherein said print optimizer means is incorporated into said printer.

23. The system of claim 7 further comprising a memory, said optimizer means being adapted to store said modified file in said memory.

24. The system of claim 7 further comprising a printer wherein said optimizer means is adapted to selectively send said modified file to said printer to print said modified document.

25. A method of printing documents comprising the steps of:
receiving a digital file representative of an original document printable on N pages;
receiving a command to optimize printing of said original document;
modifying said digital file in response to said command to obtain a modified file representative of a modified document printable on M pages, with M being less than N.

26. The method of claim 25 wherein said original document includes necessary and unnecessary content elements, wherein modifying said digital file includes deleting at least some of said unnecessary content elements.

27. The method of claim 26 wherein said original document includes text and graphic elements, further comprising deleting said graphic elements.

28. The method of claim 25 wherein said original document includes printing characteristics and wherein said step of modifying said digital files includes modifying said printing characteristics.

29. The method of claim 28 wherein said printing characteristics include at least one of a font size, font type, character spacing on a line, line spacing, spacing between words and single/double side printing.

30. The method of claim 25 further comprising generating preview information associated with said modified document.

31. The method of claim 30 wherein said preview information includes an image of said modified document.

32. The method of claim 30 wherein said preview information includes an indication of said numbers M and N.

33. The method of claim 31 further comprising making a decision on whether to accept or reject said modified file based on said preview information.

34. The method of claim 33 further comprising printing one of said original and modified documents based on said preview information.

35. The method of claim 33 further comprising storing said modified file.
